(19) United States
(12) Patent Application Publication
(10) Pub. No.: US 2010/0295813 A1
(43) Pub. Date: Nov. 25, 2010

(54) SYSTEM AND METHOD FOR A PROJECTED CAPACITIVE TOUCHSCREEN HAVING GROUPED ELECTRODES

(75) Inventor: Joel C. Kent, Fremont, CA (US)

Correspondence Address: MARGUERITE E. GERSTNER;TYCO ELECTRONICS CORPORATION, INTELLECTUAL PROPERTY LAW DEPARTMENT, 309 CONSTITUTION DRIVE M/S R34/2A, MENLO PARK, CA, 94025-1164, US

(73) Assignee: Tyco Electronics Corporation, Berwyn, PA (US)

(21) Appl. No.: 12/471,016

(22) Filed: May 22, 2009

(51) Int. Cl. G06F 3/045

(52) U.S. Cl. 345/174

(57) ABSTRACT

A projected capacitive touchscreen system has triangular-shaped electrodes coupled to a substrate. Adjacent ones of the electrodes alternate between first and second orientations to form an interleaved arrangement. The electrodes having the first orientation are electrically connected into greater than two groups that each have at least two semi-adjacent electrodes and the electrodes having the second orientation are electrically connected into at least one group that has at least two semi-adjacent electrodes. A controller detects signal levels associated with at least one touch on the substrate from the greater than two groups and the at least one group. The signal levels are used to determine both X and Y coordinate positions of the at least one touch.

### BACKGROUND OF THE INVENTION

The subject matter disclosed herein relates generally to touchscreens and touchscreen systems, and more particularly to projected capacitive touchscreens.

In a projected capacitive touchscreen, an outer surface may be provided over one or more layers having sense electrodes or sensors formed thereon. In contrast to common resistive touchscreens, the outer surface of a projected capacitive touchscreen may be a durable glass surface having high optical transparency for viewing images displayed by an underlying display device. The touchscreen may be positioned over a display device that displays graphical selections such as buttons and icons. When a user touches the outer surface with a finger, corresponding to a desired selection displayed on the display device, the touchscreen system senses a change in capacitance associated with one or more of the electrodes. “Projected capacitive” touchscreen is in contrast to a “surface capacitive” touchscreen that has a single sensing electrode covering the entire touch area. As used herein, “projected capacitive touchscreen” generalizes to any capacitive touchscreen with a plurality of sensing electrodes in the touch sensitive area.

Some projected capacitive touchscreens use a “backgammon” type of configuration for the electrodes. In this configuration, the electrodes are elongated triangles formed on a single surface. The orientation alternates with each of the electrodes, wherein a base of a first electrode is positioned proximate one edge of the surface and the base of the next or adjacent electrode is positioned proximate the opposite edge of the surface. Such electrode geometry is reminiscent of a backgammon game board pattern.

Backgammon touchscreen designs typically have a large number of narrow electrodes so that each touch is detected by at least two electrodes. For example, in some backgammon systems the electrodes detect signals that are used to determine both the X and Y coordinates. If each touch is detected by a large number of electrodes, a fraction of the total signal on the electrodes that are oriented the same way provides a good measure of one of the coordinates, such as the X or horizontal coordinate. If the triangular electrodes are too wide and few in number, the measured horizontal coordinate becomes strongly dependent on the vertical position of the touch.

Providing each electrode with a separate electronic channel to sense the change in capacitance may be costly. For example, a touchscreen system that has the backgammon electrode configuration and measures 3.5 inches diagonally may utilize close to fifty separate triangular-shaped electrodes, while a seven inch system may have more than one hundred electrodes. In contrast, one commercially available capacitance sensing chip supports a maximum of 12 signal channels, a number far smaller than the number of electrodes. Therefore, sensing each electrode separately would require multiple sensing chips. Furthermore, having more electronic signal channels generally leads to longer scan times, which may result in a slower touch response time.

### BRIEF DESCRIPTION OF THE INVENTION

In one embodiment, a projected capacitive touchscreen comprises a substrate and first and second pluralities of electrodes. The first plurality of electrodes is coupled to the substrate, and each of the electrodes is substantially triangular-shaped and has an apex and a base. The first plurality of electrodes is oriented so that the bases are positioned along one side of the substrate. The second plurality of electrodes is coupled to the substrate, and each of the electrodes is substantially triangular-shaped and has an apex and a base. The second plurality of electrodes is oriented so that the apexes are positioned proximate the same side of the substrate as the bases of the first plurality of electrodes, and the first and second plurality of electrodes alternate on the substrate. The electrodes within the first plurality of electrodes that are closest to each other are semi-adjacent and the electrodes within the second plurality of electrodes that are closest to each other are semi-adjacent. The first plurality of electrodes is separated electrically into greater than two groups of semi-adjacent electrodes and the second plurality of electrodes is separated electrically into at least one group of semi-adjacent electrodes.

In another embodiment, a projected capacitive touchscreen system comprises a substrate. Triangular-shaped electrodes are coupled to the substrate. Adjacent ones of the electrodes alternate between first and second orientations to form an interleaved arrangement. The electrodes having the first orientation are electrically connected into greater than two groups that each comprise at least two semi-adjacent electrodes and the electrodes having the second orientation are electrically connected into at least one group comprising at least two semi-adjacent electrodes. A controller is configured to detect signal levels associated with at least one touch on the substrate from the greater than two groups and the at least one group. The signal levels are used to determine both X and Y coordinate positions of the at least one touch.

In yet another embodiment, a method for interconnecting electrodes of a projected capacitive touchscreen comprises directly electrically connecting triangular-shaped electrodes having a first orientation into greater than two groups. Triangular-shaped electrodes having a second orientation are directly electrically connected into at least one group, wherein the electrodes having the first orientation alternate on a substrate with the electrodes having the second orientation. The greater than two groups and the at least one group are directly electrically connected to electronic channels configured to receive signal levels associated with at least one touch on the touchscreen.

### BRIEF DESCRIPTION OF THE DRAWINGS

FIG. 1 illustrates a projected capacitive touchscreen having a tripled backgammon electrode grouping configuration formed in accordance with an embodiment of the present invention that may be used within a touchscreen system.

FIG. 2 illustrates a side-view of the touchscreen of FIG. 1 formed in accordance with an embodiment of the present invention.

FIG. 3 illustrates a projected capacitive touchscreen that has a quintupled electrode grouping configuration formed in accordance with an embodiment of the present invention.

FIG. 4 illustrates a tripled electrode grouping configuration wherein at least a portion of the electronic channels connect to opposite-orientation electrodes along the same side of the touchscreen in accordance with an embodiment of the present invention.

FIG. 5 illustrates a modified quintupled electrode grouping configuration formed in accordance with an embodiment of the present invention.

FIG. 6 illustrates a portion of a flexible cable wherein electrodes are interconnected into groups on or within the cable in accordance with an embodiment of the present invention.

FIG. 7 illustrates an embodiment wherein the electrodes are directly electrically connected into groups within the controller in accordance with an embodiment of the present invention.

FIG. 8 illustrates an embodiment wherein the electrodes are connected into groups based on an asymmetric grouping configuration in accordance with an embodiment of the present invention.

### DETAILED DESCRIPTION OF THE INVENTION

The foregoing summary, as well as the following detailed description of certain embodiments of the present invention, will be better understood when read in conjunction with the appended drawings. To the extent that the figures illustrate diagrams of the functional blocks of various embodiments, the functional blocks are not necessarily indicative of the division between hardware circuitry. Thus, for example, one or more of the functional blocks (e.g., processors or memories) may be implemented in a single piece of hardware (e.g., a general purpose signal processor or random access memory, hard disk, or the like). Similarly, the programs may be stand alone programs, may be incorporated as subroutines in an operating system, may be functions in an installed software package, and the like. It should be understood that the various embodiments are not limited to the arrangements and instrumentality shown in the drawings.

As used herein, an element or step recited in the singular and proceeded with the word “a” or “an” should be understood as not excluding plural of said elements or steps, unless such exclusion is explicitly stated. Furthermore, references to “one embodiment” of the present invention are not intended to be interpreted as excluding the existence of additional embodiments that also incorporate the recited features. Moreover, unless explicitly stated to the contrary, embodiments “comprising” or “having” an element or a plurality of elements having a particular property may include additional such elements not having that property.

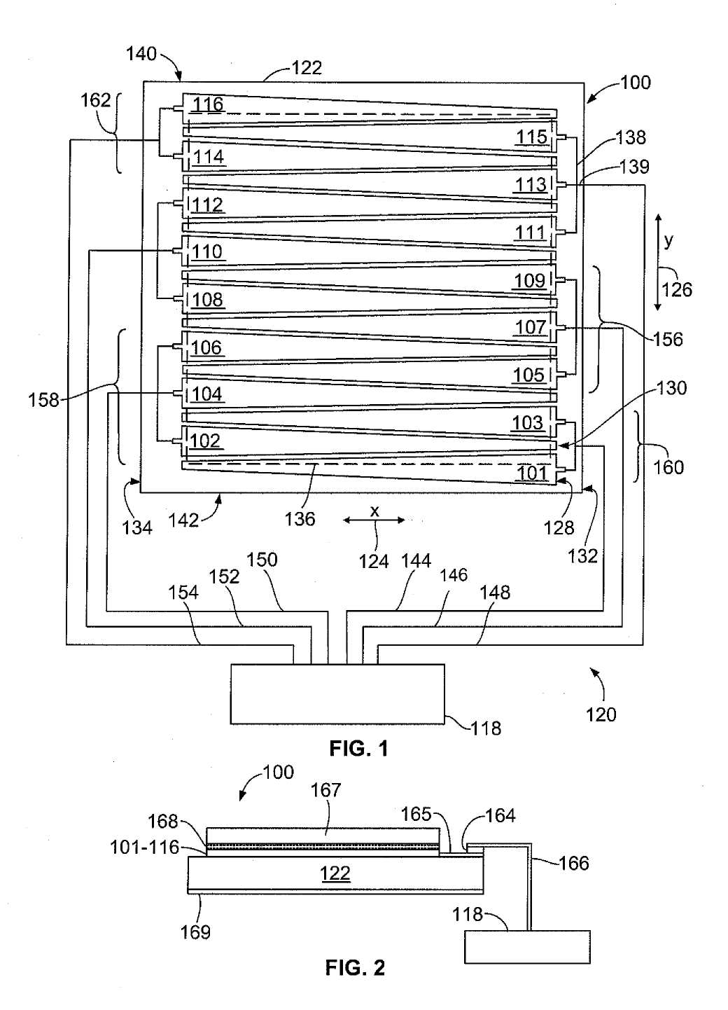

FIG. 1 illustrates a projected capacitive touchscreen 100 having a tripled backgammon electrode grouping configuration that may be used within a touchscreen system 120. Electrodes 101-116 are formed on a substrate 122 and are substantially triangular in shape. The triangular area of one of the electrodes 101-116 is an area that couples capacitively to any finger (or object) contact overlap of the triangular area; such a triangular electrode may be fabricated as a conductive film covering the entirety of the triangular area, a conductive film that incompletely fills the triangular area such as with a mesh pattern, a serpentine pattern or other pattern. For example, if an area of conductive film in the form of a solid isosceles triangle is split into two right triangular regions by a fine deletion line down the axis of the isosceles triangle, but the two right triangular conductive film regions remain electrically connected, then the two right triangular conductive film regions still form only a single triangular electrode. The substrate 122 may be glass, a polymer film such as polyethylene terephthalate (PET), or other suitable material. Each of the electrodes 101-116 may be formed of a continuous loop of a conductive material, such as by forming a serpentine pattern using fine metal wires to fill in an outline of each triangle. The wires may be, for example, between ten and twenty-five micrometers thick. In another embodiment, the electrodes 101-116 may be formed from a deposited conductive coating that may be deposited in a desired pattern, such as by using screen printing, photographic, or other process. In yet another embodiment, the conductive coating may be deposited to evenly and completely cover a surface of the substrate 122. Portions of the conductive coating may then be removed to form the triangular-shaped electrodes 101-116. The transparent conductive coating may be indium tin oxide (ITO), antimony tin oxide (ATO), a fluorine-doped tin oxide, a carbon-nanotube containing film, a silver nano-wire containing film, an intrinsically conductive polymer, and the like.

In one embodiment, traces 138 and 139 may be formed from materials such as the conductive wire, silver-frit, deposited metal films, conductive-ink, incomplete deletion-line separation of the conductive coating, and the like, to electrically join electrodes 101-116 into groups on the substrate 122. The traces 138 and 139 may also convey signals and power between individual electrodes 101-116 and a cable or cable connector (as shown in FIG. 2) and/or the groups of electrodes and the cable or cable connector.

An elongated axis of each triangular-shaped electrode 101-116 is shown as parallel to X-axis 124, although it should be understood that the electrodes 101-116 of the touchscreen 100 may be positioned such that the elongated axis is parallel to Y-axis 126. There is no overlap of individual electrodes 101-116 and all of the electrodes 101-116 may be formed on a single plane or surface of the substrate 122.

As used herein, the term “adjacent electrodes” refers to nearest-neighbor electrodes that are next to each other and have opposite orientation. For ease of description, adjacent electrodes are numbered sequentially. For example, electrodes 101 and 102 are adjacent electrodes, and electrodes 102 and 103 are adjacent electrodes.

The orientation of adjacent electrodes 101-116 is reversed or alternating with respect to each other, forming an interleaved arrangement. For example, base 128 of the electrode 101 is positioned adjacent to apex 130 of the adjacent electrode 102. Therefore, a first plurality of electrodes, or odd-numbered electrodes 101, 103, 105, 107, 109, 111, 113, and 115, has an orientation wherein the bases 128 of the odd-numbered electrodes are all proximate the same side, for example right side 132, of the substrate 122. A second plurality of electrodes, or the even-numbered electrodes 102, 104, 106, 108, 110, 112, 114, and 116, has an opposite orientation compared to the orientation of the odd-numbered electrodes, wherein the bases 128 of the even-numbered electrodes are proximate left side 134 of the substrate 122. The right and left sides 132 and 134 are opposite first and second sides of the substrate 122, and thus “right” and “left” are used herein for convenience with respect to the figures.

As used herein, the term “semi-adjacent electrodes” refers to nearest-neighbor electrodes that have the same orientation. For example, electrodes 101 and 103 are semi-adjacent electrodes and electrodes 102 and 104 are semi-adjacent electrodes.

Each capacitance measuring electronic channel 144, 146, 148, 150, 152 and 154 provided within controller 118 is directly connected to a group of semi-adjacent electrodes. As discussed herein, a “group” includes a minimum of two electrodes 101-116. In some embodiments, a group includes less than half the total number of electrodes 101-116 in the touchscreen 100. In one embodiment, the semi-adjacent odd-numbered electrodes 101, 103, 105, 107, 109, 111, 113 and 115 may be grouped into at least two groups, while the semi-adjacent even-numbered electrodes 102, 104, 106, 108, 110, 112, 114 and 116 may be grouped into at least two additional groups.

As shown in FIG. 1, electrode 116 is the electrode closest to top side 140 of the substrate 122 and electrode 101 is closest to bottom side 142. Proximate the top and bottom sides 140 and 142, groups having two semi-adjacent electrodes may be formed. For example, electrodes 101 and 103 form a group 160 that is connected to the electronic channel 144, and electrodes 114 and 116 form a group 162 that is connected to the electronic channel 154.

Between the outermost groups 160 and 162, groups having three semi-adjacent electrodes may be formed. The electrodes 105, 107 and 109 form a group 156 that is connected to the electronic channel 146, electrodes 102, 104 and 106 form a group 158 that is connected to the electronic channel 150, and so on.

As shown, the configuration of FIG. 1 would form six groups that are connected to six electronic channels 144-154, reducing the required number of electronic channels compared to a system that connects each electrode 101-116 to a separate electronic channel. In addition, effects of electronic noise on coordinate measurements may be reduced because the scan speed may be increased, providing more individual measurements for noise suppression via signal averaging within a given period of time for each electronics channel. It should be understood that for a given number of electronic channels, such as twelve electronic channels, the touchscreen 100 may include many more electrodes 101-116 than are shown in FIG. 1, thus providing more linear position measurements and/or a larger size touchscreen 100.

In one embodiment, the touchscreen 100 may have thirty-four electrodes connected into groups as shown in FIG. 1. A controller 118 comprising twelve electronic channels may be used. Therefore, two electronic channels may each be connected to a pair of semi-adjacent electrodes located along top and bottom sides 140 and 142 while ten electronic channels may each be connected to three semi-adjacent electrodes that are located between the outer-most groups.

FIG. 2 illustrates a side-view of the touchscreen 100. The electrodes 101-116 are attached to the substrate 122 and are coupled to a flexible cable 166 via interconnect traces 165, which may be metalized or other conductive traces, and a conductive adhesive bond 164, which may be an anisotropic conductive film (ACF). For example, termination pads within the interconnect traces 165 may be electrically connected to termination pads within the flexible cable 166 via an anisotropic conductive film. The flexible cable 166 is also coupled to the touchscreen electronics or the controller 118. A durable transparent layer of glass, polycarbonate or other suitable material forming touch surface 167 may be mechanically coupled to the electrodes 101-116, such as with an adhesive layer 168. In one embodiment, a guard electrode 169 may optionally be deposited on a bottom surface of the substrate 122 to minimize the effects of stray capacitances between the electrodes 101-116 and, for example, a display device (not shown) placed behind the touchscreen 100. Alternatively, guard electrode 169, adhesive layer 168 and touch surface 167 may be absent and sense electrodes 101-116 may be used to detect touches applied to the substrate 122 on the surface opposite to the electrodes 101-116.

The electrodes 101-116 are configured to sense one or more touches occurring simultaneously within touch area 136 as shown in FIG. 1. The amount of signal that is generated depends on at least the overall size of the touch and the thickness of the touch surface 167. A thicker touch surface 167 may result in a larger sensed touch area due to lateral spreading of electric field lines going from the finger or other object to electrodes 101-116. The detected signals from the electrodes 101-116 are used to determine both the X and the Y coordinate of the touch(es). Also, because more than one simultaneous touch may be detected at the same time, gestures such as zoom-in, zoom-out and rotate may be determined by the controller 118.

The controller 118 detects a touch in contact with the touch surface 167 when, for example, capacitance levels detected from a group 156, 158, 160 and 162 exceeds a threshold. In one embodiment, the threshold may be a signal amplitude and may be used to determine the Y coordinate. To determine the X coordinate, signals from all of the groups 156, 158, 160, and 162 of odd- and even-numbered electrodes 101-116 may be considered. For example, a touch that occurs closer to the bases 128 of a plurality of odd-numbered electrodes will generate bigger signals on the odd-numbered electrodes compared to the adjacent even-numbered electrodes. The X coordinate may thus be determined by a ratio of the signals between the groups 156 and 160 of odd-numbered electrodes and the groups 158 and 162 of even-numbered electrodes. It should be understood that other detection algorithms may be used.

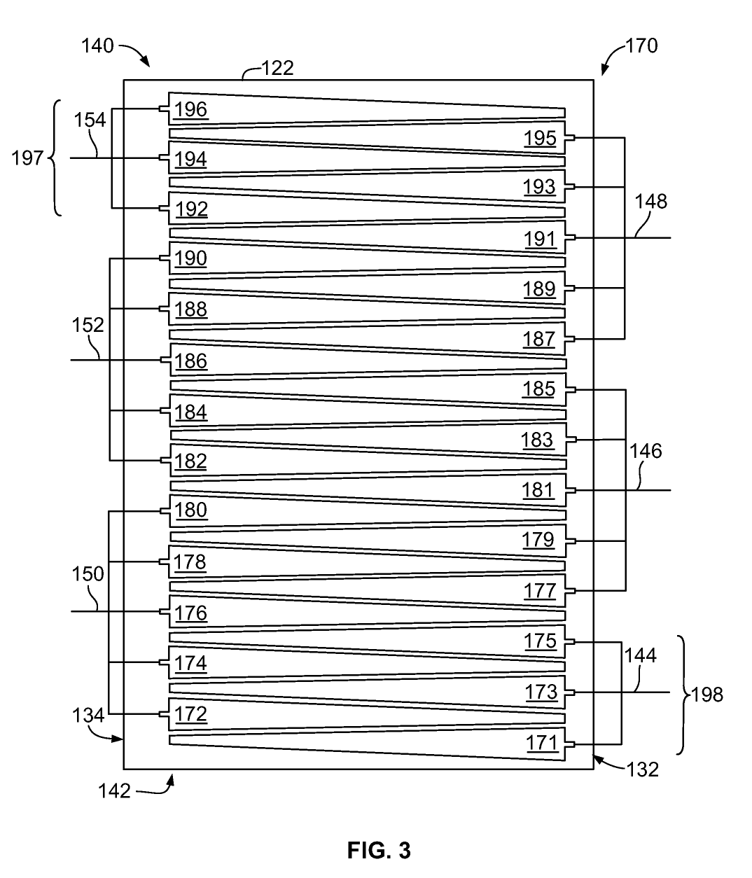

FIG. 3 illustrates a projected capacitive touchscreen 170 that has a quintupled electrode grouping configuration. Electrodes 171-196 are joined into groups that are larger than the groups of FIG. 1. Even-number electrode 196 is proximate the top side 140 of the substrate 122 and odd-numbered electrode 171 is proximate the bottom side 142. The semi-adjacent even-numbered electrodes 192, 194 and 196 are grouped into a group 197 of three electrodes connected to electronic channel 154 and the semi-adjacent odd-numbered electrodes 171, 173 and 175 are grouped into a group 198 of three electrodes connected to electronic channel 144. Between the groups 197 and 198, the semi-adjacent odd-numbered electrodes are grouped into groups of five semi-adjacent electrodes and the semi-adjacent even-numbered electrodes are grouped into groups of five semi-adjacent electrodes, each connected to a different electronic channel.

For the illustrated interconnection configurations wherein an odd number of electrodes are connected together into groups, the centers of the odd-numbered groups, shown connected to electronic channels 146 and 148 in FIG. 1 and electronic channels 144, 146 and 148 in FIG. 3, are equidistant, or evenly spaced, with respect to each other. Similarly, the centers of the even-numbered groups, shown connected to the electronic channels 150 and 152 in FIG. 1 and electronic channels 150 and 152 in FIG. 3, are evenly spaced with respect to each other. Furthermore, the center of the group connected to electronic channel 152 is vertically centered between the centers of the groups connected to electronic channels 146 and 148. In some embodiments, additional processing may be needed to process the signals if an even number of electrodes form a group as the centers of the groups may not be evenly space with respect to each other.

In one embodiment, the touchscreen 170 may have fifty-six electrodes grouped as shown in FIG. 3, while the controller 118 provides twelve electronic channels. Therefore, two electronic channels may each be connected to three semi-adjacent electrodes near the top and bottom sides 140 and 142 while the remaining ten electronic channels are each connected to five semi-adjacent electrodes. Therefore, more groups of five semi-adjacent electrodes would be formed.

In other embodiments, each electronic channel may be connected to more or less semi-adjacent electrodes compared to the groups shown in FIGS. 1 and 3. Also, groups that are connected to different numbers of semi-adjacent electrodes may be formed between the outer-most groups. The electronic channels may be connected to groups having even and/or odd numbers of semi-adjacent electrodes. For example, at least one electronic channel may be connected to an even number of electrodes, such as 4, 6, 8, or 10 or more electrodes. In some cases groups of 7, 9 or 11 or more electrodes may be appropriate.

FIGS. 1 and 3 illustrate examples wherein the electronic channels 144-154 are connected to the bases 128 of the electrodes 101-116 and 171-196. Therefore, the electronic channels 144, 146, and 148 are connected to the odd-numbered electrodes along the right side 132 of the touchscreens 100 and 170 and the electronic channels 150, 152, and 154 are connected to the even-numbered electrodes along the left side 134. In another embodiment, the electronic channels 144-154 may be connected to all of the electrodes 101-116 and 171-196 on the same side of the touchscreen 100.

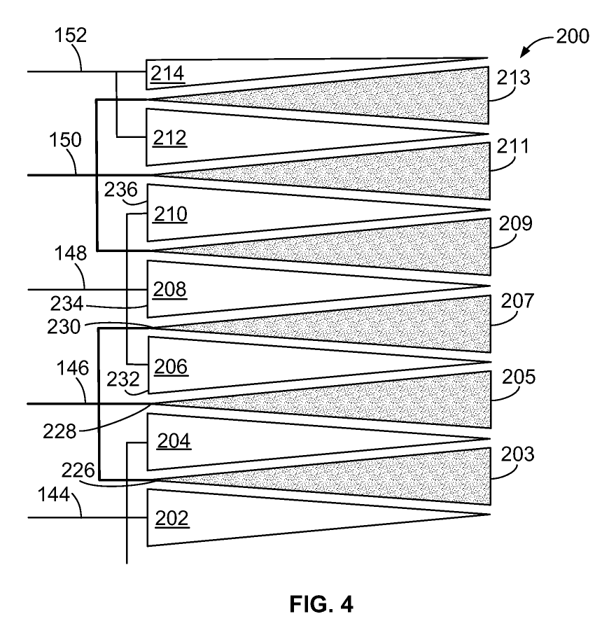

FIG. 4 illustrates a tripled electrode grouping configuration 200 wherein at least a portion of electronic channels 144-152 connect to the electrodes 202-214 along the same side of the touchscreen. There may be additional electronic channels and electrodes that are not shown. Even-numbered electrodes 202, 204, 206, 208, 210, 212, and 214 are grouped into groups and odd-numbered electrodes 203, 205, 207, 209, 211, and 213 are grouped into groups. Electronic channel 146 connects to apexes 226, 228 and 230 of odd-numbered electrodes 203, 205 and 207, connecting the semi-adjacent electrodes 203, 205 and 207 into a group. Electronic channel 148 connects to bases 232, 234 and 236 of even-numbered electrodes 206, 208 and 210, connecting the semi-adjacent electrodes 206, 208 and 210 into another group.

In one embodiment, all of the electronic channels 144-152 may connect to the odd and even-numbered electrodes 202-214 on the same side of the touchscreen. In another embodiment, other electronic channels (not shown) may connect to additional electrodes (not shown) on the opposite side of the touchscreen. The decision on where to connect the electrodes 202-214 to the electronic channels 144-152 may be based on interconnect space available along one or more sides of the touchscreen, additional uses of the touchscreen along one or more sides, such as additional touch buttons (not shown), and the like. Therefore, not all of the electronic channels 144-152 may be used to detect signals from the electrodes 202-214.

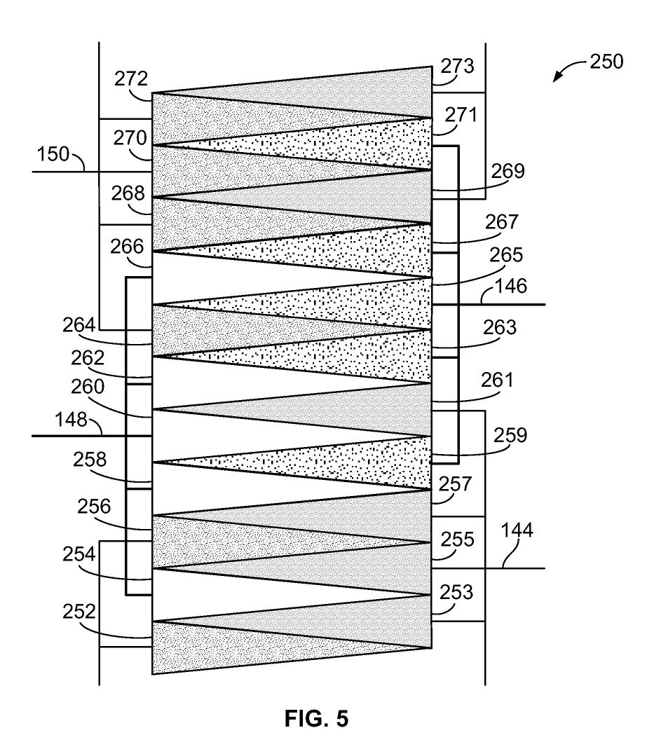

FIG. 5 illustrates a modified quintupled electrode grouping configuration 250. Electrodes 252-273 illustrate a portion of the total number of electrodes that may be used. Odd-numbered electrodes 253, 255, 257, 259, 261, 263, 265, 267, 269, 271, and 273 are grouped into groups and even-numbered electrodes 252, 254, 256, 258, 260, 262, 264, 266, 268, 270, and 272 are grouped into groups. Each of the groups includes at least two semi-adjacent electrodes. At least a portion of the groups may include at least one electrode that is not semi-adjacent. As used herein, the term quasi-semi-adjacent is used to identify an electrode that is included within a group of at least two semi-adjacent electrodes, but is separated from the semi-adjacent electrodes by at least one semi-adjacent electrode that belongs to a different group, but that has the same orientation as the other electrodes in the group.

For example, odd-numbered electrodes 259, 263, 265, 267 and 271 may all be connected to the same electronic channel 146. Electrodes 263, 265 and 267 are semi-adjacent with respect to each other, while electrodes 259 and 271 are quasi-semi-adjacent to electrodes 263 and 267, respectively. Electrode 261, positioned semi-adjacent to both electrodes 259 and 263, is connected to a different group of electrodes that is connected to electronic channel 144. Electrode 269, positioned semi-adjacent to both electrodes 267 and 271, is connected to yet another different group of electrodes that is connected to a different electronic channel.

In one embodiment, the configuration of FIG. 5 may support fifty-two electrodes with twelve electronic channels. Eight of the electronic channels may each be connected to five electrodes as illustrated. The electrodes near the outer edges (such as the top and bottom sides 140 and 142 of the substrate 122 as shown in FIG. 1) may be grouped into groups that include different numbers of semi-adjacent electrodes and/or quasi-semi-adjacent electrodes. For example, at one outer edge, one electronic channel may be connected to two quasi-semi-adjacent electrodes on either the left or right side, while a different electronic channel may be connected to three semi-adjacent electrodes and one quasi-semi-adjacent electrode on the other side.

When all of the electrodes detecting a touch are connected to only one odd-numbered electrode group and only one even-numbered electrode group, the controller 118 may not be able to determine where the touch is located within the area covered by the electrodes. With the configuration of FIG. 5, however, even when five odd-numbered electrodes are grouped together, because the outside electrodes are quasi-semi-adjacent and an intermediate electrode is included within a different odd-numbered electrode group, it is less likely that a touch will generate signals in only two groups. With more groups of electrodes generating touch signals, there is more information for the controller 118 to more smoothly reconstruct touch coordinates.

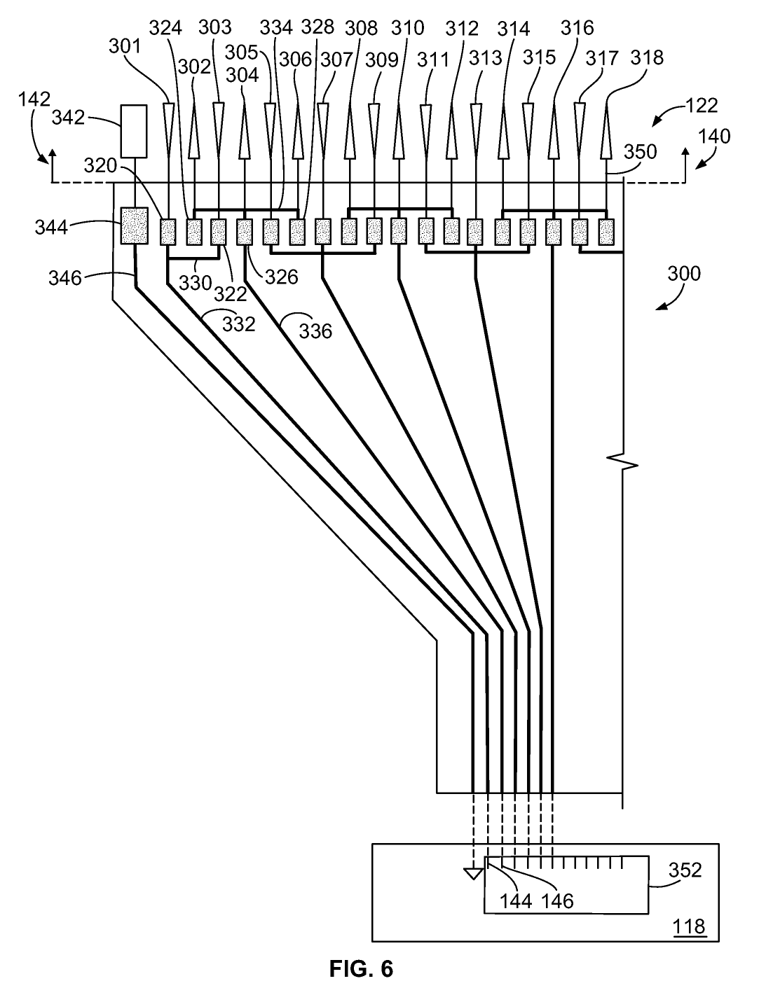

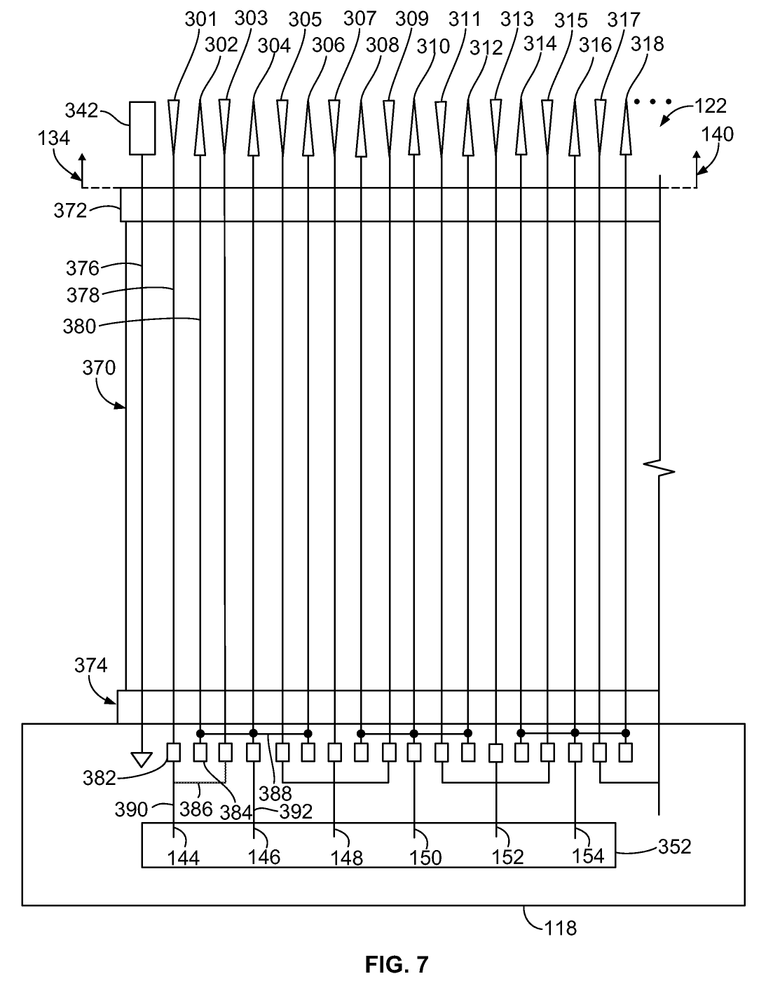

In one embodiment, the electrodes may be grouped into groups on the substrate 122, such as by electrically connecting the electrodes 101-116 together with the traces 138 and 139 as shown in FIG. 1. In another embodiment discussed below with respect to FIG. 6, the electrodes may be connected into groups by a cable (such as the cable 166 shown in FIG. 2) that conveys the signals and power between the substrate 122 and the controller 118. In yet another embodiment, the electrodes may be virtually connected or hardwired together within the controller 118, such as via copper trace interconnections as discussed below with respect to FIG. 7. It should be understood that various combinations of electrical connections may be used, wherein some electrodes may be grouped together on the substrate, others of the electrodes may be grouped together by the cable, while still others may be grouped together within the controller 118.

FIG. 6 illustrates a portion of a flexible cable 300 wherein electrodes 301-318 are interconnected into groups on or within the cable 300. Again, the triangular-shaped electrodes are positioned on the substrate 122 such that the odd-numbered or first set of electrodes 301, 303, 305, 307, 309, 311, 313, 315 and 317 have one orientation and the even-numbered or second set of electrodes 302, 304, 306, 308, 310, 312, 314, 316 and 318 have the alternate orientation. In general, a metalized trace 350 (one trace is indicated for clarity) may extend from each of the electrodes 301-318 on the substrate 122. The metallized traces 350 may be interconnected to the cable 300 through a conductive adhesive bond 164 as shown on FIG. 2. The cable 300 may then connect to a circuit board, which may also be referred to as the controller 118. The electronic channels may be provided within an integrated circuit that may be provided on a separate chip 352. Although only one chip 352 is shown, it should be understood that additional chips 352 may be included within the controller 118 to provide additional electronic channels.

Each of the electrodes 301-318 is connected to a separate conductive pad within the cable 300. For example, odd-numbered electrodes 301 and 303 are connected to conductive pads 320 and 322, respectively. Similarly, even-numbered electrodes 302, 304 and 306 are connected to conductive pads 324, 326 and 328, respectively. As shown in FIG. 6, the electrodes 301-318 are grouped in the same tripled group configuration as FIG. 1. That is, the electrodes 301-318 within a central portion of the touchscreen are directly electrically connected into triples, or groups of three semi-adjacent electrodes. The electrodes 301-318 along the top and bottom sides 140 and 142 of the substrate 122 are grouped into groups of two semi-adjacent electrodes.

The conductive pads 320 and 322 are tied together with a trace 330 or other conductive connection, and are connected to one line 332 that extends from at least one of the trace 330 and/or at least one of the conductive pads 320 and 322, to the controller 118. The conductive pads 324, 326 and 328 are tied together with a trace 334 and are connected to one line 336 that extends from at least one of the trace 334 and/or at least one of the conductive pads 324, 326 and 328 to the controller 118. As illustrated, the line 336 extends from the center of electrode 304 of the group that includes electrodes 302, 304 and 306. Therefore, the signals from the electrodes 301-318 are conveyed through the cable 300 using twelve lines 332 and 336 (only a portion are shown), corresponding to the number of electronic channels available in the controller 118. For example, the lines 332 and 334 may be connected to first and second electronic channels 144 and 146 on the chip 352.

In one embodiment, a guard electrode or shield 342 may be formed on the substrate 122 and connected to a separate conductive pad 344 within the cable 300. A line 346 connects the conductive pad 344 to the controller 118, which may connect the line 346 to ground. The shield 342 may be an electrode formed in the same plane or surface of the substrate 122 as the electrodes 301-318 and may be used to minimize the effects of stray capacitances to objects around the perimeter of the touchscreen, such as metal associated with a bezel (not shown) or other supporting structures (also not shown).

In one embodiment wherein the electrodes 301-318 are grouped into groups on the substrate 122 as shown in FIG. 1, the cable 300 may provide a line for each group. In another embodiment wherein the electrodes 301-318 are grouped into groups at the controller 118 as shown in FIG. 7, the cable 300 may provide a line for each electrode 301-318.

Although FIG. 6 illustrates grouping the electrodes 301-318 into groups of three semi-adjacent electrodes, the electrodes 301-318 may also be grouped into other sizes of groups and may include electrodes that are not semi-adjacent, such as the quasi-semi adjacent group configuration of FIG. 5.

FIG. 7 illustrates an embodiment wherein the electrodes 301-318 are directly electrically connected into groups within the controller 118. A flexible cable 370 may be connected to the substrate 122 via conductive adhesive bond 372 and to the controller 118 via a connector 374. The cable 370 has a separate line 376, 378 and 380 (not all lines are indicated) for the shield 342 and each of the electrodes 301-318.

The lines 378 and 380 from each of the electrodes 301-318 are connected into groups within the controller 118. Each of the lines 378 and 380 are directly electrically connected to, for example, electrical nodes 382 and 384 that may be formed on a circuit board. Traces 386, 388, 390 and 392 may be formed to directly electrically connect the electrical nodes 382 and 384 together in the desired group configuration, and also to directly electrically connect the groups to the electronic channels 144-154.

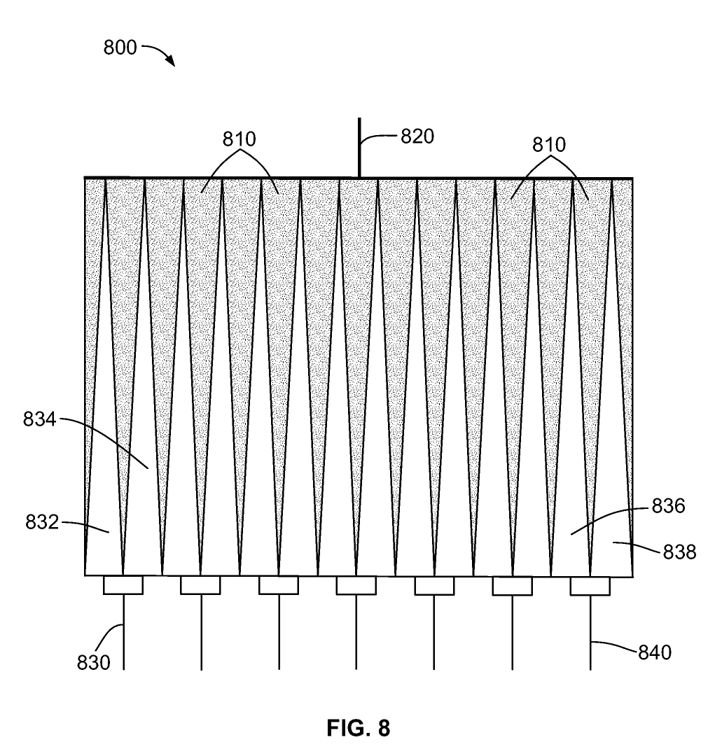

In FIGS. 1, 3, 4 and 5 the electrodes of the two orientations are grouped in a similar manner, which may be referred to as a symmetric design. This contrasts to the more asymmetric design of electrode grouping 800 shown in FIG. 8. All downward oriented triangular electrodes 810 may be electrically connected together and to only one electronic channel 820. Triangular electrodes of the opposite orientation, such as electrodes 832, 834, 836 and 838 are electrically connected in pairs. For example, semi-adjacent electrodes 832 and 834 are connected to electronic channel 830 while semi-adjacent electrodes 836 and 838 are electrically connected to electronic channel 840. In the orientation shown, the vertical coordinate is determined from the fraction of the total touch signal detected in electronic channel 820. The distribution of touch signals on the remaining electronic channels from channel 830 through channel 840 is used to determine the horizontal touch coordinate. As illustrated in FIG. 8, eight electronic channels are connected to 29 triangular electrodes. Depending on the size of the touchscreen relative to the finger contact area, it may be desirable to have a larger number of narrower triangular electrodes supported by a larger number of electronic channels and/or larger groups of electrodes per electronic channel.

Although the embodiments shown in FIGS. 1 and 3-8 illustrate electrodes that are substantially triangular-shaped, it should be understood that other shapes may be used. Referring to FIG. 1, electrodes 102, 104, 106, 108, 110, 112, 114 and 116 are in the shape of triangles whose width decreases monotonically going left to right while oppositely oriented electrodes 101, 103, 105, 107, 109, 111, 113 and 115 have widths that increase monotonically going left to right. It is because of this monotonic variation in width along the axes of the electrodes that the division of the touch signal between the two sets of electrodes provides a measure of the coordinate parallel to the axes of the electrodes. A simple triangle or truncated triangle is the simplest electrode geometry with this monotonic width variation and is the special case where the variation is linear. However, other electrode geometries may be used including ones in which the electrode width varies monotonically, but not linearity along the axis of the electrode. Such altered electrode geometries may be used, for example, to provide hardware edge acceleration as described in co-pending patent application Ser. No. ______ that is assigned to the same Assignee, filed May 22, 2009, and titled “Electrode Configurations for Projected Capacitive Touch Screen”, which is herein incorporated by reference in its entirety.

It is to be understood that the above description is intended to be illustrative, and not restrictive. For example, the above-described embodiments (and/or aspects thereof) may be used in combination with each other. In addition, many modifications may be made to adapt a particular situation or material to the teachings of the invention without departing from its scope. This written description uses examples to disclose the invention, including the best mode, and also to enable any person skilled in the art to practice the invention, including making and using any devices or systems and performing any incorporated methods. While the dimensions and types of materials described herein are intended to define the parameters of the invention, they are by no means limiting and are exemplary embodiments. Many other embodiments will be apparent to those of skill in the art upon reviewing the above description. The scope of the invention should, therefore, be determined with reference to the appended claims, along with the fill scope of equivalents to which such claims are entitled. In the appended claims, the terms “including” and “in which” are used as the plain-English equivalents of the respective terms “comprising” and “wherein.” Moreover, in the following claims, the terms “first,” “second,” and “third,” etc. are used merely as labels, and are not intended to impose numerical requirements on their objects. Further, the limitations of the following claims are not written in means-plus-function format and are not intended to be interpreted based on 35 U.S.C. §112, sixth paragraph, unless and until such claim limitations expressly use the phrase “means for” followed by a statement of function void of further structure.

What is claimed is:

1. A projected capacitive touchscreen, comprising:
a substrate;
a first plurality of electrodes coupled to the substrate, each of the electrodes being substantially triangular-shaped and having an apex and a base, the first plurality of electrodes being oriented so that the bases are positioned along one side of the substrate; and
a second plurality of electrodes coupled to the substrate, each of the electrodes being substantially triangular-shaped and having an apex and a base, the second plurality of electrodes being oriented so that the apexes are positioned proximate the same side of the substrate as the bases of the first plurality of electrodes, the first and second plurality of electrodes alternating on the substrate, the electrodes within the first plurality of electrodes that are closest to each other being semi-adjacent and the electrodes within the second plurality of electrodes that are closest to each other being semi-adjacent, the first plurality of electrodes being separated electrically into greater than two groups of semi-adjacent electrodes and the second plurality of electrodes being separated electrically into at least one group of semi-adjacent electrodes.

2. The touchscreen of claim 1, wherein at least one of the groups of the first plurality comprises at least three semi-adjacent electrodes.

3. The touchscreen of claim 1, wherein at least one of the groups of the first plurality comprises five semi-adjacent electrodes.

4. The touchscreen of claim 1, further comprising electronic channels configured to receive signal levels associated with at least one touch from the greater than two groups of the first plurality and the at least one group of the second plurality, and wherein the signal levels are used to determine both X and Y coordinate positions of the at least one touch.

5. The touchscreen of claim 1, wherein one of the greater than two groups further comprises at least two semi-adjacent electrodes and at least one electrode from within the first plurality of electrodes that is separated from the at least two semi-adjacent electrodes by at least one electrode that is electrically connected to a different group within the greater than two groups.

6. The touchscreen of claim 1, wherein the first plurality of electrodes are electrically connected on the substrate to form the greater than two groups.

7. The touchscreen of claim 1, further comprising:
a controller; and
a cable configured to convey at least one of electronic signals and power between the substrate and the controller, and wherein the groups of the electrodes within the first plurality of electrodes are electrically connected by the cable to form the greater than two groups.

8. The touchscreen of claim 1, further comprising a controller configured to receive signals detected by the first and second pluralities of electrodes, wherein the groups of the electrodes within the first plurality of electrodes are electrically connected within the controller to form the at least two groups.

9. The touchscreen of claim 1, further comprising electronic channels within a controller, wherein each of the greater than two groups of the first plurality is directly electrically connected to separate ones of the electronic channels.

10. A projected capacitive touchscreen system, comprising:
a substrate;
triangular-shaped electrodes coupled to the substrate, adjacent ones of the electrodes alternating between a first and second orientation to form an interleaved arrangement, the electrodes having the first orientation being electrically connected into greater than two groups, each of the groups comprising at least two semi-adjacent electrodes, and the electrodes having the second orientation being electrically connected into at least one group comprising at least two semi-adjacent electrodes; and
a controller configured to detect signal levels associated with at least one touch on the substrate from the greater than two groups and the at least one group, the signal levels being used to determine both X and Y coordinate positions of the at least one touch.

11. The touchscreen system of claim 10, wherein the electrodes are directly electrically connected into the greater than two groups and wherein the greater than two groups are directly electrically connected to the controller.

12. The touchscreen system of claim 10, wherein one of greater than two groups further comprises at least one electrode having the first orientation that is separated from the at least two semi-adjacent electrodes by at least one other electrode that has the first orientation and that is connected to a different one of the greater than two groups.

13. The touchscreen system of claim 10, wherein the substrate further comprises opposite first and second sides, wherein the greater than two groups having the first orientation is connected on the right side and the at least one group having the second orientation is connected on the second side.

14. The touchscreen system of claim 10, wherein the substrate further comprises opposite first and second sides, wherein the greater than two groups having the first orientation is connected on the right side and the at least one group having the second orientation is connected on the first side.

15. The touchscreen system of claim 10, further comprising a cable configured to convey the signal levels between the electrodes and the controller, and wherein the electrodes are electrically connected into the greater than two groups by the cable.

16. A method for interconnecting electrodes of a projected capacitive touchscreen, comprising:
directly electrically connecting triangular-shaped electrodes having a first orientation into greater than two groups;
directly electrically connecting triangular-shaped electrodes having a second orientation into at least one group, wherein the electrodes having the first orientation alternate on a substrate with the electrodes having the second orientation; and
directly electrically connecting the greater than two groups and the at least one group to electronic channels configured to receive signal levels associated with at least one touch on the touchscreen.

17. The method of claim 16, further comprising determining both X and Y coordinate positions of at least one touch based on the signal levels from the greater than two groups and the at least one group.

18. The method of claim 16, further comprising forming the triangular-shaped electrodes having the first and second orientations on a single surface.

19. The method of claim 16, further comprising directly electrically connecting at least two semi-adjacent electrodes having the first orientation to form one of the greater than two groups.

20. The method of claim 16, further comprising directly electrically connecting at least two semi-adjacent electrodes having the first orientation and at least a third electrode having the first orientation to form one of the greater than two groups, the at least a third electrode being separated from the at least two semi-adjacent electrodes by at least one other electrode having the first orientation.
